(19) United States
(12) Patent Application Publication
(10) Pub. No.: US 2010/0033887 A1
(43) Pub. Date: Feb. 11, 2010

(54) OVERVOLTAGE AND/OR UNDERVOLTAGE PROTECTION DEVICE

(76) Inventor: See Ni Fong, Kuala Lampur (MY)

Correspondence Address: MATTHIAS SCHOLL, 14781 MEMORIAL DRIVE, SUITE 1319, HOUSTON, TX, 77079, US

(21) Appl. No.: 12/527,268

(22) PCT Filed: Jan. 17, 2008
(86) PCT No.: PCT/MY08/00002

§ 371 Date: Aug. 14, 2009

(30) Foreign Application Priority Data
Feb. 16, 2007 (MY) PI 20070232

(51) Int. Cl. H02H 3/20; H02H 3/24

(52) U.S. Cl. 361/91.1; 361/92

(57) ABSTRACT

The overvoltage and/or undervoltage protection device (1, 2) of this invention provides a novel way in solving the problems faced by user of an existing electrical installation zone when the user adds overvoltage and/or undervoltage protection feature into the existing electrical installation. One of the key features of the invention is the tripping initiation circuit (11) that simulates an earth leakage condition to trip the earth leakage protection device (41, 42) installed in the existing electrical installation zone when an overvoltage and/or undervoltage condition is detected by the decision logic (12) of the overvoltage and/or undervoltage protection device (1, 2) of this invention. The single phase overvoltage and/or undervoltage protection device (1) of this invention can be packaged as a three-prong plug to facilitate the use of the device while, the three phase overvoltage and/or undervoltage protection device (2) can be packaged as a single DIN rail mounted device. The overvoltage and/or undervoltage protection device (1, 2) can be further provided with a test button to test integrity of the earth leakage protection device (41, 42), the overvoltage and/or undervoltage protection device (1, 2) of this invention and the wiring connections and/or annunciator to indicate the user that the tripping was caused by overvoltage or undervoltage.

### BACKGROUND OF THE INVENTION

An overvoltage condition in an electrical installation occurs when the voltage in the particular electrical installation zone rises above its upper design limit. When this condition happens, the voltage supply to the electronic and electrical devices connected to that electrical installation zone are all exposed to an overvoltage condition. As electronic and electrical devices are designed to operate at a certain rated voltage, considerable damage can be caused by voltage that is higher than that for which the devices are rated.

An undervoltage condition may also cause damages on electronic and electrical devices connected to the electrical installation zone. Electric motor will be heated up quickly under a low voltage condition because if the applied voltage to the motor is dropped, the torque and the speed of the motor will correspondingly be reduced hence causing an increase in motor current which will heat up the motor quickly. This excess heat built-up inside the motor is harmful to the motor.

It is therefore desirable to protect electrical installation zones against overvoltage and/or undervoltage condition to minimise risk of damage to devices connected to the electrical installation zones. Overvoltage and/or undervoltage protection devices of prior art comprises a voltage sensor that measures the voltage of the electrical installation zone and provides the voltage measured to a decision logic. The decision logic compares the measured voltage with a predefined overvoltage and/or undervoltage condition. When a predefined overvoltage or undervoltage condition is detected, the design logic delivers a trip command to energise the electromechanical tripping coil of the circuit breaker which in turn actuates the tripping mechanism of the circuit breaker. The tripping coil or shunt coil is usually an optional component of the circuit breaker. Smaller circuit breakers, particularly the single phase circuit breakers do not have the option for the addition of a shunt coil. Additional installation and wiring is needed when a tripping mechanism is added to such circuit breakers. Such modification or addition is best left only to qualified electrical service personnel to avoid undesirable fatal electrocution and to ensure correct wiring for proper working of the added shunt coil and tripping mechanism. Additional costs are therefore involved, with possible inconvenience caused by disruption to continuous electricity supply during the installation.

It is therefore desirable to have an overvoltage and/or undervoltage protection device that can protect an electrical installation against overvoltage and/or undervoltage without having to undertake any additional electrical wiring to the electrical installation zone and therefore would not incur additional costs or causes discontinuity of electricity supply in the implementation.

### SUMMARY OF INVENTION

It is an object of the present invention to provide an overvoltage and/or undervoltage protection device that works cooperatively with the earth leakage protection device installed to protect an electrical installation zone and devices, apparatus and equipment connected thereto against earth leakage fault. When an overvoltage or undervoltage is detected, the overvoltage and/or undervoltage protection device of this invention simulates an earth leakage current to earth, thereby causing the earth leakage circuit protection device to trip. This obviates the requirement for the addition of any shunt tripping coil and tripping mechanism to the existing circuit breaker of an electrical installation zone, if such addition could be plausible.

It is another object of the present invention to provide an overvoltage and/or undervoltage protection device that is portable and convenient to use; for instance packaging the overvoltage and/or undervoltage protection device as a three-prong plug that can be easily and conveniently plugged into any matching socket in the electrical installation zone to be protected or as a switch like device in the electrical installation zone to be protected or, in the case of a three phase installation zone, as a panel mounted device such as DIN rail mounted device as per DIN 46277 and DIN EN 50022 suitable for mounting on the distribution board of the three phase installation zone to be protected.

It is another objective of this invention to provide an overvoltage and/or undervoltage protection device that enables the user to readily test the integrity of the overvoltage protection device, the earth leakage protection device and the wiring connection to the overvoltage and/or undervoltage protection device.

It is yet another objective of the present invention to provide an overvoltage and/or undervoltage protection device that provides indication that the tripping is caused by overvoltage or undervoltage condition. By this the user would be able to infer that the tripping of the earth leakage protection device is a result of overvoltage or undervoltage instead of earth leakage fault.

The use of the overvoltage and/or undervoltage protection device of the present invention therefore has the advantage of avoiding possible disruption to the continuity of electricity supply to the protected electrical installation zone when a shunt coil or tripping mechanism need to be added to the existing circuit breaker.

### BRIEF DESCRIPTION OF THE DRAWINGS

The features and usefulness of the invention will be more readily appreciated from the following detailed description when read in conjunction with the accompanying drawing, in which:

FIG. 1 is a block diagram of the overvoltage and/or undervoltage protection device of this invention.

FIG. 2 is a block diagram of a three phase overvoltage and/or undervoltage protection device adapted for application on a three-phase electrical installation zone.

### DETAILED DESCRIPTION OF THE INVENTION

The invention will now be described with reference to the accompanying drawings, wherein like reference numerals designate corresponding or identical elements throughout the drawings. Since the earth leakage protection device (41, 42) is not a component of the overvoltage and/or undervoltage protection device (1, 2) of this invention and since an earth leakage protection device is a commercially available component, its operation is well known to those skilled in the art and is not described here.

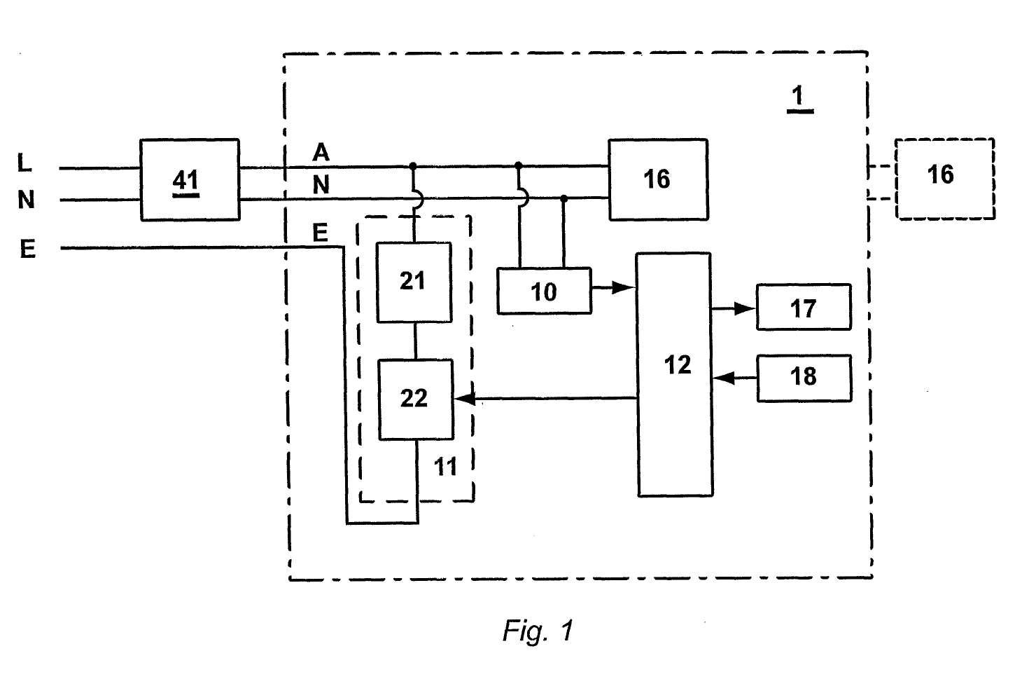

In FIG. 1, the reference numeral (1) may designate an overvoltage protection device, an undervoltage protection device or an overvoltage and undervoltage protection device. In the descriptions below, the phrase “overvoltage and/or undervoltage protection device” is taken to mean that the device may be an overvoltage protection device, an undervoltage protection device or an overvoltage and undervoltage protection device as is fit for the situation. As will be clear in the description below, the configuration for an overvoltage protection device, an undervoltage protection device or an overvoltage and undervoltage protection device of this invention is the same except for the decision logic which may be settable to selectively detects only overvoltage or only undervoltage or both overvoltage and undervoltage conditions.

In accordance with the present invention, it is provided an overvoltage and/or undervoltage protection device (1) for use cooperatively together with an earth leakage protection device (41) such as a RCD (residual current device) or GFCI (ground fault circuit interrupter) or ELCB (earth leakage circuit breaker) to trip power supply to a protected electrical installation zone in the event of overvoltage or undervoltage condition being detected.

Referring to FIG. 1, the overvoltage and/or undervoltage protection device (1) comprises a voltage sensor (10), a tripping initiation circuit (11), a decision logic (12), means for connecting the overvoltage and/or undervoltage protection device (1) to the Live, Neutral and Earth wires of the protected electrical installation zone and means for receiving and applying power supply (16,) to the overvoltage and/or undervoltage protection device (1).

The voltage sensor (10) is electrically connected across terminals (A) and (N) as shown in FIG. 1. When connected to the electrical installation zone to be protected, the voltage sensor (10) continuously measures the voltage between the Live and Neutral wires of the protected electrical installation zone. The output of the voltage sensor (10) is connected to one of the input ports of the decision logic (12) to enable the decision logic (12) to monitor voltage values as measured by the voltage sensor (10). Two of the preferred embodiments of the voltage sensor (10) are step down transformer and voltage divider.

The trip initiation circuit (11) is electrically connected across terminals (A) and (E) as shown in FIG. 1. The trip initiation circuit (11) comprises a current limiting resistor (21) and a switch (22). The preferred embodiments for the switch (22) are either an electronic switch or an electromechanical switch. The switching on and off of the switch (22) is controlled by the decision logic (12). The switching-on command from the decision logic (12) causes the switch (22) to close, allowing an earth leakage current to flow through the current limiting resistor (21) to earth. The earth leakage current will cause the earth leakage protection device (41) to trip and cut off the electricity supply to the electrical installation zone protected by the earth leakage protection device (41). As will be explained later, the switching-on command is delivered by the decision logic (12) to the switch (22) of the trip initiation circuit (11) when the decision logic (12) detects an overvoltage or undervoltage condition, as is appropriate.

In the case of an electronic switch, the preferred embodiment for the electronic switch is either a triac or a solid state relay. In the case of an electromechanical switch, the switch (22) is a pair of normally open contacts of an electromechanical relay.

In the case of electronic switch such as triac or solid state relay, on receiving a switching-on command from the decision logic (12), the electronic switch closes, causing earth leakage current to flow through the current limiting resistor (21) to earth. The earth leakage current in turn causes the earth leakage protection device (41) to trip.

In the case of electromechanical switch such as electromechanical relay, the pair of normally open contacts closes when the electromechanical relay is energized on receiving a switching-on command from the decision logic (12), the closing of the pair of contacts results in earth leakage current flowing through the current limiting resistor (21) to earth. The earth leakage in turn causes the earth leakage protection device (41) to trip and interrupt electricity supply to the protected electrical installation zone.

The decision logic (12) has at least one input port and at least one output port with an input port electrically connected to receive the output of the voltage sensor (10) and with an output port electrically connected to the tripping initiation circuit (11) to enable the decision logic (12) to control the tripping initiation circuit (11). The decision logic (12) is adapted to monitor and compare the voltage as measured by the voltage sensor (10) against a defined overvoltage or undervoltage condition. When the decision logic (12) detects an overvoltage or an undervoltage condition, the decision logic (12) is adapted to generate and deliver a switching-on command to close the switch (22) of the tripping initiation circuit (11), allowing earth leakage current to flow through the current limiting resistor (21) to earth. The earth leakage current causes the earth leakage protection device (41) to trip and this cut off power supply to the electrical installation zone protected by the overvoltage and/or undervoltage protection device (1). The decision logic (12) can be a discrete digital circuit, a discrete analogue circuit, a discrete analogue and digital circuit, a digital microprocessor or a digital microcontroller. The decision logic (12) includes a comparator to compare the voltage as measured by the voltage sensor (10) to a predefined overvoltage and/or undervoltage condition designed or preprogrammed into the decision logic (12). For instance, the predefined overvoltage condition is said to occur when the voltage of the electrical installation zone exceeds a predefined voltage for a predefined duration of time. Similarly, the predefined undervoltage condition is said to occur when the voltage of the electrical installation zone fell below a predefined voltage for a predefined duration of time. The above is an example of definite time protection. The decision logic (12) is understood to include a timer or software controlled timer for such definite time tripping characteristic feature. It is also possible to have an inverse time characteristic built into the decision logic (12) or to allow for selectable settings for the predefined overvoltage or undervoltage condition. In situation where memory is required, as will be described later, the decision logic (12) can be provided with a memory if the decision logic (12) is a discrete digital circuit and/or a discrete analogue circuit. If the decision logic (12) is a digital microprocessor or a digital microcontroller, the decision logic (12) can have a software controlled memory included therein.

The overvoltage and/or undervoltage protection device (1) is provided with a source of power supply for its proper functioning. The power supply unit (16) can be in the form of an AC/DC converter that is connected to the live and neutral wires of the protected electrical installation zone when the overvoltage and/or undervoltage protection device is connected to the protected installation zone during use.

The power supply unit (16) can alternatively be an external source (shown in dotted line in FIG. 1) such as a battery. When the power supply unit (16) is a battery, it is desirable to open the switch (22) of the tripping initiation circuit (11) after the lapse of the trip response time of the earth leakage protection device (41). For this purpose, the decision logic (12) delivers a switch-off command to open the switch (22) of the tripping initiation circuit (11). In the case of an electronic switch, the triac or solid state relay will be switched off. In the case of electromechanical switch, the electromechanical relay will be de-energised by the switching-off command of the decision logic (12) and the electromechanical switch will revert back to its normally open position.

The overvoltage and/or undervoltage protection device (1) can be further provided with an annunciator (17) connected to one of the output ports of the decision logic (12). When the decision logic (12) detects a predefined overvoltage or undervoltage condition, the decision logic (12) sends a switching-on command to the switch (22) of the tripping initiation circuit (11) and simultaneously sends a command to turn on the annunciator (17). The purpose of turning on the annunciator (17) is to indicate that the tripping of the earth leakage protection device (41) is triggered by a defined overvoltage or undervoltage condition so as to differentiate between a tripping caused by an overvoltage or undervoltage condition from one caused by earth leakage. The annunciator (17) can be electrical type or mechanical type. The preferred annunciator (17) is light emitting electrical type such as indicator lamp, light-emitting diodes or LCD. When annunciator (17) is of electrical type and the power supply (16) is of AC/DC converter, the tripping of the earth leakage protection device (41) will cut off power supply to the light-emitting type of annunciator. In this particular embodiment, the decision logic (12) will need to be provided with a memory to register the tripping event. The electrical type annunciator (17) will turns on when the power supply resumes. If the annunciator (17) is of mechanical type such as a flag or if the overvoltage and/or undervoltage protection device is powered by battery, the annunciation works without the requirement of a memory to store the trip event in the decision logic (12).

The overvoltage and/or undervoltage protection device (1) can be further provided with a test button (18) connected to one of the input ports of the decision logic (12) to test the integrity of the overvoltage and/or undervoltage protection device (1), the earth leakage protection device (41) and the wiring connection to the overvoltage and/or undervoltage protection device (1). When the test button (18) is actuated, the decision logic (12) of the overvoltage and/or undervoltage protection device (1) sends a switching on command to close the switch (22) of the tripping initiation circuit (11) to simulate an earth leakage condition. The tripping of the earth leakage protection device (41) affirms the proper functioning of the overvoltage and/or undervoltage protection device (1), the earth leakage protection device (41) and the correctness of the wiring connections to the overvoltage and/or undervoltage protection device (1). If the earth leakage protection device (41) fails to trip when the test button (18) is actuated, attention is needed to troubleshoot the cause of the non-tripping.

The overvoltage and/or undervoltage protection device (1) is preferably packaged as a portable three-prong plug that can be plugged into any socket within the electrical installation zone protected by the earth leakage protection device (41). For this purpose, the terminals, (A), (N) and (E) of the overvoltage and/or undervoltage protection device (1) are connected respectively to the Live, Neutral and Earth prongs of a three-prong plug. When the overvoltage and/or undervoltage protection device (1) packaged in the form of a three-prong plug is plugged into any socket within the protected electrical installation zone, terminals (A) (N) and (E) of the overvoltage and/or undervoltage protection device (1) will be connected respectively to the Live, Neutral and Earth wires of the electrical installation zone to be protected. The annunciator (17) and test button (18) can be positioned on the opposing face to the prongs of the three prong plug.

Sockets are generally readily available at different locations within an electrical installation zone to be protected. Thus, the implementation of the overvoltage and/or undervoltage protection of this invention can be readily and easily accomplished by merely plugging in the overvoltage and/or undervoltage protection device (1) packaged as a three-prong plug into any available socket within the electrical installation zone to be protected. Even in electrical installation zone where the sockets are fully utilized by various appliances, an extension cord or a socket adaptor can be used to provide the spare socket needed for the insertion the overvoltage and/or undervoltage protection device (1) packaged as a three-prong plug.

In the case where the power supply (16) of the overvoltage and/or undervoltage protection device (1) is an external battery, the three prong plug can be designed to have a chamber to accommodate the battery.

The overvoltage and/or undervoltage protection device (1) can be used for the protection of a three phase electrical installation zone. This is accomplished by identifying at least one socket that is associated with each of the three phases of the electrical installation zone and plugging one overvoltage and/or undervoltage protection device (1) packaged in the form of a three-prong plug into each socket associated with each of the three phases.

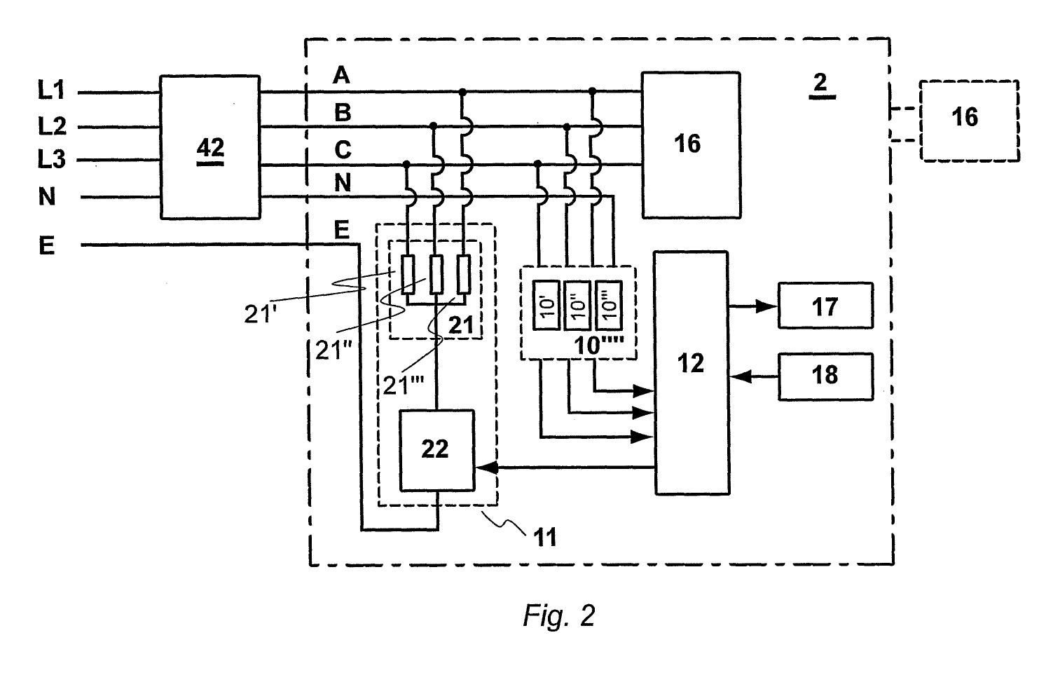

FIG. 2 is the block diagram of a three phase overvoltage and/or undervoltage protection device (2) provided as an integral unit for use cooperatively together with a three phase earth leakage protection device (42) such as a RCD (residual current device) or GFCI (ground fault circuit interrupter) or ELCB (earth leakage circuit breaker) to trip power supply to a protected three phase electrical installation zone in the event of an overvoltage and/or undervoltage condition being detected on any of the phase of the protected three phase electrical installation zone.

In FIG. 2, the reference numeral (2) may designate a three phase overvoltage protection device, a three phase undervoltage protection device or a three phase overvoltage and undervoltage protection device. In the descriptions below, the phrase “three phase overvoltage and/or undervoltage protection device” is taken to mean the device may be a three phase overvoltage protection device, a three phase undervoltage protection device or a three phase overvoltage and undervoltage protection device as is fit for the situation. As will be clear in the description below, the configuration for a three phase overvoltage protection device, a three phase undervoltage protection device or a three phase overvoltage and undervoltage protection device are the same except for the decision logic which may be settable to selectively detects only overvoltage or only undervoltage or both overvoltage and undervoltage.

As shown in FIG. 2, the three phase overvoltage and/or undervoltage protection device (2) comprises a voltage sensor group (10″″) comprising at least two voltage sensors but preferably three voltage sensors (10′, 10″, 10′″) a tripping initiation circuit (11), a decision logic (12), means for connecting the overvoltage and/or undervoltage protection device (2) to the Live wires of each phase of the protected three phase electrical installation zone and to the Neutral and Earth wires of the protected three phase electrical installation zone and means for receiving and applying power supply (16) to the overvoltage and/or undervoltage protection device (2).

Each of the voltage sensors (10′, 10″, 10′″) is connected in use across one phase of the three phase electrical installation zone. One end of each of the voltage sensors (10′, 10″, 10′″) are respectively electrically connected to terminals (A), (B) and (C) of the three phase overvoltage and/or undervoltage device (2) and the other end of each voltage sensors (10′, 10″, 10′″) is connected to terminal (N) of the three phase overvoltage and/or undervoltage protection device (2). When connected to the three phase electrical installation zone to be protected, the voltage sensors (10′, 10″, 10′″) continuously measure the voltage across the respective Live wires of each phase of the protected three phase electrical installation zone. Each of the outputs of the voltage sensors (10′, 10″, 10′″) is connected to an input port of the decision logic (12) to enable the decision logic (12) to monitor voltage values as measured by the voltage sensors (10′, 10″, 10′″). Alternatively, the voltage measurement can be made on any two of the three phases of the protected three phase electrical installation zone, with the voltage of the third phase computed by the decision logic (12). In this configuration, a voltage sensor group (10″″) with just two voltage sensors would be adequate to perform the requisite task. Two of the preferred embodiments of the voltage sensors (10′, 10″, 10′″) are a three phase step down transformer and voltage divider. Alternatively, the voltage sensors (10′, 10″, 10′″) can be substituted with a three phase voltage sensors (not shown)

The trip initiation circuit (11) comprises at least one current limiting resistor (21′, 21″ or 21′″) connected in series with a switch (22). In an embodiment where three current limiting devices (21′, 21″, 21′″) are used, one end of the current limiting resistors (21′, 21″, 21′″) is respectively connected to terminals (A), (B) and (C) of the three phase overvoltage and/or undervoltage protection device (42) and the other end to the switch (22), while the other end of the switch is connected to terminal (E). The preferred embodiments for the switch (22) are either an electronic switch or an electromechanical switch. The switching on and off of the switch (22) is controlled by the decision logic (12). The switching-on command from the decision logic (12) causes the switch (22) to close, allowing an earth leakage current to flow through the current limiting resistors (21′, 21″, 21′″) to earth. The earth leakage current will cause the three phase earth leakage protection device (42) to trip and cut off the electricity supply to the electrical installation zone protected by the three phase earth leakage protection device (42). As will be explained later, the switching-on command is delivered by the decision logic (12) to the switch (22) of the trip initiation circuit (11) when the decision logic (12) detects an overvoltage or undervoltage condition, as is appropriate, on any of the three phases of the protected three phase electrical installation zone.

In the case of an electronic switch, the preferred embodiment for the electronic switch is either a triac or a solid state relay. In the case of an electromechanical switch, the switch (22) is a pair of normally open contacts of an electromechanical relay.

In the case of electronic switch such as triac or solid state relay, on receiving a switching-on command from the decision logic (12), the electronic switch closes, causing earth leakage current to flow through the current limiting resistors (21′, 21″, 21′″) to earth. The earth leakage current in turn causes the three phase earth leakage protection device (42) to trip.

In the case of electromechanical switch such as electromechanical relay, the pair of normally open contacts closes when the electromechanical relay is energized on receiving a switching-on command from the decision logic (12), the closing of the pair of normally open contacts results in earth leakage current flowing through the current limiting resistors (21′, 21″, 21′″) to earth. The earth leakage current in turn causes the three phase earth leakage protection device (42) to trip and interrupt electricity supply to the protected three phase electrical installation zone.

The decision logic (12) has at least three input ports and at least one output port with one input port each electrically connected to receive the output of each of the voltage sensors (10′, 10″, 10″) and with an output port electrically connected to the tripping initiation circuit (11) to enable the decision logic (12) to deliver command to the tripping initiation circuit (11). The decision logic (12) is adapted to monitor and compare the voltage as measured by each of the voltage sensors (10′, 10″, 10′″) against a defined overvoltage or undervoltage condition. When the decision logic (12) detects an overvoltage or an undervoltage condition, the decision logic (12) is adapted to generate and deliver a switching-on command to close the switch (22) of the tripping initiation circuit (11), allowing earth leakage current to flow through the current limiting resistors (21′, 21″, 21′″) to earth. The earth leakage current causes the three phase earth leakage protection device (42) to trip and this cut off power supply to the three phase electrical installation zone protected by the three phase overvoltage and/or undervoltage protection device (2). The decision logic (12) can be a discrete digital circuit, a discrete analogue circuit, a discrete digital and analogue circuit, a digital microprocessor or a digital microcontroller. The decision logic (12) includes a comparator to compare the voltage as measured by each of the voltage sensors (10′, 10″, 10′″) to a predefined overvoltage and/or undervoltage condition designed or preprogrammed into the decision logic (12). For instance, the predefined overvoltage condition is said to occur when the voltage on any phase of the three phase electrical installation zone exceeds a predefined voltage for a predefined duration of time. Similarly, the predefined undervoltage condition is said to occur when the voltage on any phase of the three phase electrical installation zone fell below a predefined voltage for a predefined duration of time. The above is an example of definite time protection. The decision logic (12) is understood to include a timer or software controlled timer for such definite time tripping characteristic feature. It is also possible to have an inverse time characteristic built into the decision logic (12) or to allow for selectable settings for the predefined overvoltage or undervoltage condition. In situation where memory is required, as will be described later, the decision logic (12) can be provided with a memory if the decision logic (12) is a discrete digital circuit and/or a discrete analogue circuit. If the decision logic (12) is a digital microprocessor or a digital microcontroller, the decision logic (12) can have a software controlled memory included therein.

The three phase overvoltage and/or undervoltage protection device (2) is provided with a source of power supply for its proper functioning. The power supply (16) can be in the form of an AC to DC converter that is connected to any or all of the phases of the protected three phase electrical installation zone when the three phase overvoltage and/or undervoltage protection device (42) is connected to the protected installation zone during use.

The power supply (16) can alternatively be an external source (shown in dotted line in FIG. 2) such as a battery. When the power supply (16) is a battery, it is desirable to open the switch (22) of the tripping initiation circuit (11) after the lapse of the trip response time of the three phase earth leakage protection device (42). For this purpose, the decision logic (12) delivers a switch-off command to open the switch (22) of the tripping initiation circuit (11). In the case of an electronic switch, the triac or solid state relay will be switched off. In the case of electromechanical switch, the electromechanical relay will be de-energised by the switching-off command of the decision logic (12) and the electromechanical switch will revert back to its normally open position.

The three phase overvoltage and/or undervoltage protection device (2) can be further provided with an annunciator (17) connected to one of the output ports of the decision logic (12). When the decision logic (12) detects a predefined overvoltage or undervoltage condition, the decision logic (12) sends a switching-on command to the switch (22) of the tripping initiation circuit (11) and simultaneously sends a command to turn on the annunciator (17). The purpose of turning on the annunciator (17) is to indicate that the tripping of the three phase earth leakage protection device (42) is triggered by a defined overvoltage or undervoltage condition so as to differentiate between a tripping caused by an overvoltage or undervoltage condition from one caused by earth leakage. The annunciator (17) can be electrical type or mechanical type. The preferred annunciator (17) is light emitting electrical type such as indicator lamp, light-emitting diodes or LCD. When annunciator (17) is of electrical type and the power supply (16) is of AC/DC converter, the tripping of the three phase earth leakage protection device (42) will cut off power supply to the light-emitting type of annunciator. In this particular embodiment, the decision logic (12) will need to be provided with a memory to register the tripping event. The electrical type annunciator (17) will turns on when the power supply resumes. If the annunciator (17) is of mechanical type such as a flag or if the overvoltage and/or undervoltage protection device is powered by battery, the annunciation works without the requirement of a memory to store the trip event in the decision logic (12).

The three phase overvoltage and/or undervoltage protection device (2) can be further provided with a test button (18) connected to one of the input ports of the decision logic (12) to test the integrity of the three phase overvoltage and/or undervoltage protection device (2), the three phase earth leakage protection device (42) and the wiring connection to the three phase overvoltage and/or undervoltage protection device (2). When the test button (18) is actuated, the decision logic (12) of the three phase overvoltage and/or undervoltage protection device (2) sends a switching on command to close the switch (22) of the tripping initiation circuit (11) to simulate an earth leakage condition. The tripping of the three phase earth leakage protection device (42) affirms the proper functioning of the three phase overvoltage and/or undervoltage protection device (2), the three phase earth leakage protection device (42) and the correctness of the wiring connections to the three phase overvoltage and/or undervoltage protection device (2). If the three phase earth leakage protection device (42) fails to trip when the test button (18) is actuated, attention is needed to troubleshoot the cause of the nor-tripping.

The three phase overvoltage and/or undervoltage device (2) can be packaged as a single DIN mounted device suitable for mounting on the distribution board of the three phase installation zone to be protected. In this packaging configuration, when in use, terminals (A), (B) and (C) are connected to the load side of the respective phase of the three-phase earth leakage protection device (42) and terminal (N) to load side of the neutral of the protected three phase electrical installation zone. Although some wirings are required to put the three phase overvoltage and/or undervoltage device (2) in operation, the user still obviates the need of adding shunt coil or trip mechanism to the breaker, which as mentioned earlier, may not be provided in smaller circuit breaker at the time of initial installation.

In the above description, the terminologies used in the description such as receptacle, Live wire, Earth wire, Earth wire, prong may differ in different countries. For example, socket may alternatively be known as receptacle, Live wire as Hot Lead, Earth wire as Ground wire, prong as blade or pin etc and these are taken interchangeably to mean the same without departing from the spirit of this invention.

The invention can be implemented as an overvoltage protection device, an undervoltage protection device or an overvoltage and undervoltage protection device. The components for these three embodiments are the same except for the decision logic (12) which can appropriately be designed or programmed to detect either a predefined overvoltage, undervoltage or both overvoltage and undervoltage condition.

Although the present invention have been described in detail above with certain preferred embodiments, those skilled in the art will readily appreciate that many modifications are possible in the exemplary embodiments above without materially departing from the novel teachings of this invention. Accordingly, all such modifications are intended to be included within the scope of this invention as defined in the following claims or equivalent thereof.

1-57. (canceled)

58. An overvoltage protection device to protect a particular electrical installation zone against overvoltage, the overvoltage protection device comprising:
a voltage sensor;
means for connecting the voltage sensor to the live and neutral wires of the electrical installation zone to be protected;
a tripping initiation circuit;
means for connecting the tripping initiation circuit to the live and earth wires of the electrical installation zone to be protected;
a decision logic having at least one input port and at least one output port, with an input port electrically connected to receive the output of the voltage sensor and with an output port electrically connected to the tripping initiation circuit to enable the decision logic to deliver command to the tripping initiation circuit and wherein the decision logic is adapted to monitor and compare the voltage so measured by the voltage sensor to a defined overvoltage condition; and
means for receiving and applying power supply to the overvoltage protection device;
wherein the tripping initiation circuit comprises a current limiting resistor and a switch connected in series;
wherein the overvoltage protection device is used cooperatively with an earth leakage protection device installed to protect the electrical installation zone; and
wherein in the event of the detection of a defined overvoltage condition by the decision logic, the decision logic is adapted to generate and deliver an output switching on command to close the switch of the tripping initiation circuit to enable an earth leakage current to flow through the current limiting resistor to earth, thereby tripping the earth leakage protection device and the electricity supply to the protected electrical installation zone.

59. The overvoltage protection device of claim 58, wherein the overvoltage protection device is packaged as a portable three-prong plug that can be plugged into any matching socket within the protected electrical installation zone and wherein the means for connecting the voltage sensor to the live and neutral wires of the protected electrical installation zone and the means for connecting the tripping initiation circuit to the live and earth wires of the protected electrical installation zone are the Live, Neutral and Earth prongs of the three-prong plug appropriately wired to the overvoltage protection device.

60. The overvoltage protection device of claim 58, wherein the switch in the tripping initiation circuit is an electronic switch and wherein the electronic switch is switched on upon receiving a switching-on command from the decision logic.

61. The overvoltage protection device of claim 58, wherein the switch in the tripping initiation circuit is an electromechanical switch.

62. The overvoltage protection device of claim 58, wherein the overvoltage protection device is further provided with at least one annunciator connected to an output port of the decision logic to indicate that the tripping of the earth leakage protection device is triggered by an overvoltage in the protected installation zone.

63. An undervoltage protection device to protect a particular electrical installation zone against undervoltage, the undervoltage protection device comprising:
a voltage sensor;
means for connecting the voltage sensor to the live and neutral wires of the electrical installation zone to be protected;
a tripping initiation circuit;
means for connecting the tripping initiation circuit to the live and earth wires of the electrical installation zone to be protected;
a decision logic having at least one input port and at least one output port, with an input port electrically connected to receive the output of the voltage sensor and with an output port electrically connected to the tripping initiation circuit to enable the decision logic to deliver command to the tripping initiation circuit and wherein the decision logic is adapted to monitor and compare the voltage so measured by the voltage sensor to a defined undervoltage condition; and
means for receiving and applying power supply to the undervoltage protection device;
wherein the tripping initiation circuit comprises a current limiting resistor and a switch connected in series;
wherein the undervoltage protection device is used cooperatively with an earth leakage protection device installed to protect the electrical installation zone; and
wherein in the event of the detection of a defined undervoltage condition by the decision logic, the decision logic is adapted to generate and deliver an output switching on command to close the switch of the tripping initiation circuit to enable an earth leakage current to flow through the current limiting resistor to earth, thereby tripping the earth leakage protection device and the electricity supply to the protected electrical installation zone.

64. The undervoltage protection device of claim 63, wherein the undervoltage protection device is packaged as a portable three-prong plug that can be plugged into any matching socket within the protected electrical installation zone and wherein the means for connecting the voltage sensor to the live and neutral wires of the protected electrical installation zone and the means for connecting the tripping initiation circuit to the live and earth wires of the protected electrical installation zone are the Live, Neutral and Earth prongs of the three-prong plug appropriately wired to the undervoltage protection device.

65. The undervoltage protection device of claim 63, wherein the switch in the tripping initiation circuit is an electronic switch and wherein the electronic switch is switched on upon receiving a switching-on command from the decision logic.

66. The undervoltage protection device of claim 63, wherein the switch in the tripping initiation circuit is an electromechanical switch.

67. The undervoltage protection device of claim 63, wherein the undervoltage protection device is further provided with at least one annunciator connected to an output port of the decision logic to indicate that the tripping of the earth leakage protection device is triggered by an undervoltage in the protected installation zone.

68. A three-phase overvoltage protection device to protect a particular three phase electrical installation zone against overvoltage, the three phase overvoltage protection device comprising:
a voltage sensor group;
means for connecting the voltage sensor group to at least two of the live wires, L1, L2, L3 and to the neutral wire N of the three phase electrical installation zone to measure the voltage on at least two of the three phases of the protected electrical installation zone;
a tripping initiation circuit comprising:
at least one current limiting resistor;
means for connecting one end of the or each current limiting resistor respectively to one or each live wire L1, L2, L3 of the protected three phase electrical installation zone;
a switch; and
means for connecting one end of the switch to the earth wire E of the protected three phase electrical installation zone;
wherein the other end of the or each current limiting resistor is electrically connected to the other end of the switch;
a decision logic having at least three input ports and at least one output port, with three of the input ports electrically connected to receive the outputs of the voltage sensor group and with an output port electrically connected to the tripping initiation circuit to enable the decision logic to deliver command to the tripping initiation circuit and wherein the decision logic is adapted to test the voltages so measured by the voltage sensor group against a defined overvoltage or undervoltage condition; and
means for receiving and applying power supply to the three phase overvoltage protection device,
wherein the three phase overvoltage protection device is used cooperatively with an earth leakage protection device installed to protect the electrical installation zone; and
wherein in the event of the detection, by measurement or by computation, of a defined overvoltage condition on any phase by the decision logic, the decision logic is adapted to generate and deliver an output switching on command to close the switch of the tripping initiation circuit to enable an earth leakage current to flow through the or each current limiting resistor to earth, thereby tripping the three phase earth leakage protection device and the electricity supply to the protected three phase electrical installation zone.

69. The three-phase overvoltage protection device of claim 68, wherein the three phase overvoltage protection device is packaged as a DIN rail mounted device as per DIN 46277 and DIN EN 50022 suitable for mounting on the distribution board of the three phase installation zone to be protected; and wherein means for connecting each of the voltage sensors in the voltage sensor group to the respective live wires, L1, L2, L3 and neutral wire N of the three phase installation zone to be protected and means for connecting the tripping initiation circuit to the respective live wires, L1, L2, L3 and the wire E of the three phase installation zone to be protected are the terminals provided on the DIN rail mounted device and appropriately wired thereto.

70. The three-phase overvoltage protection device of claim 68, wherein the voltage sensor group comprises three voltage sensors each respectively connected to one of the live wires of each phase of the three phase electrical installation zone and with each output electrically connected to one input port each of the decision logic.

71. The three-phase overvoltage protection device of claim 68, wherein the voltage sensor group comprises a three phase voltage sensor connected respectively to the live wires of each phase of the three phase electrical installation zone and with each output electrically connected to one input port each of the decision logic.

72. The three-phase overvoltage protection device of claim 68, wherein the three phase overvoltage protection device is further provided with at least one annunciator.

73. A three-phase undervoltage protection device to protect a particular three phase electrical installation zone against undervoltage, the three phase undervoltage protection device comprising:
a voltage sensor group;
means for connecting the voltage sensor group to at least two of the live wires, L1, L2, L3 and to the neutral wire N of the three phase electrical installation zone to measure the voltage on at least two of the three phases of the protected electrical installation zone;
a tripping initiation circuit comprising:
at least one current limiting resistor;
means for connecting one end of the or each current limiting resistor respectively to one or each live wire L1, L2, L3 of the protected three phase electrical installation zone;
a switch; and
means for connecting one end of the switch to the earth wire E of the protected three phase electrical installation zone;
wherein the other end of the or each current limiting resistor is electrically connected to the other end of the switch;
a decision logic having at least three input ports and at least one output port, with three of the input ports electrically connected to receive the outputs of the voltage sensor group and with an output port electrically connected to the tripping initiation circuit to enable the decision logic to deliver command to the tripping initiation circuit and wherein the decision logic (12) is adapted to test the voltages so measured by the voltage sensor group against a defined undervoltage condition; and
means for receiving and applying power supply to the three phase undervoltage protection device,
wherein the three phase undervoltage protection device is used cooperatively with an earth leakage protection device installed to protect the electrical installation zone; and
wherein in the event of the detection, by measurement or by computation, of a defined undervoltage condition on any phase by the decision logic, the decision logic is adapted to generate and deliver an output switching on command to close the switch of the tripping initiation circuit to enable an earth leakage current to flow through the or each current limiting resistor to earth, thereby tripping the three phase earth leakage protection device and the electricity supply to the protected three phase electrical installation zone.

74. The three-phase undervoltage protection device of claim 73, wherein the three phase undervoltage protection device is packaged as a DIN rail mounted device as per DIN 46277 and DIN EN 50022 suitable for mounting on the distribution board of the three phase installation zone to be protected; and wherein means for connecting each of the voltage sensors in the voltage sensor group to the respective live wires, L1, L2, L3 and neutral wire N of the three phase installation zone to be protected and means for connecting the tripping initiation circuit (11) to the respective live wires, L1, L2, L3 and the wire E of the three phase installation zone to be protected are the terminals provided on the DIN rail mounted device and appropriately wired thereto.

75. The three-phase undervoltage protection device of claim 73, wherein the voltage sensor group comprises three voltage sensors each respectively connected to one of the live wires of each phase of the three phase electrical installation zone and with each output electrically connected to one input port each of the decision logic.

76. The three-phase undervoltage protection device of claim 73, wherein the voltage sensor group comprises a three phase voltage sensor connected respectively to the live wires of each phase of the three phase electrical installation zone and with each output electrically connected to one input port each of the decision logic.

77. The three-phase undervoltage protection device of claim 73, wherein the three phase undervoltage protection device is further provided with at least one annunciator.
